(19) United States
(12) Patent Application Publication
(10) Pub. No.: US 2014/0229324 A1
(43) Pub. Date: Aug. 14, 2014

(54) METHOD AND SYSTEM FOR RECOMMENDING ITEMS

(71) Applicant: THOMSON LICENSING, Issy de Moulineaux (FR)

(72) Inventors: Gregory D. GUDORF, San Diego, CA (US); Manuele WAHL, Boulogne (FR); Saurabh MATHUR, Danville, CA (US); Vincent E. Duffy, Canyon Country, CA (US)

(73) Assignee: THOMSON LICENSING, Issy de Moulineaux (FR)

(21) Appl. No.: 14/221,776

(22) Filed: Mar. 21, 2014

Related U.S. Application Data
(63) Continuation-in-part of application No. 14/170,486, filed on Jan. 31, 2014.
(60) Provisional application No. 61/762,821, filed on Feb. 8, 2013.

(51) Int. Cl. G06Q 30/06

(52) U.S. Cl. CPC G06Q 30/0631
USPC 705/26.7

(57) ABSTRACT

The disclosure presents information about a user selected item. A determination is made about attributes of the selected item and from such attributes sample items are shown to a user which have similar attributes to that of the user selected item. The user is presented with a representation of the sample item and is provided with information as to what attribute of the sample item is similar to the attributes of the user selected item.

This application claims benefit as a continuation in part under 35 U.S.C. §120 from U.S. patent application Ser. No. 14/170,486 that was filed Jan. 31, 2014 which claims priority under 35 U.S.C. §119(e) of U.S. Provisional Application 61/762,821 that was filed on Feb. 8, 2013.

### TECHNICAL FIELD

The disclosure is related towards a method and apparatus for providing information about items, and more particularly to a method and apparatus that recommend items that are physically similar to a user selected item available through an electronic commerce vendor.

### BACKGROUND

When a user is interested in buying an item through an electronic commerce vendor such as AMAZON, WAL-MART, NORDSTROM, and the like, the user will be interested in the physical characteristics of the item such as the color, size, texture, material of the item, and the like. However, a textual description of the characteristics of an item may not be sufficient to accurate describe the physical attributes of the item. For example, if the item being queried is an article of clothing, the color of the article of clothing in person can be different than the image shown on the website of the electronic commerce vendor. This variation between the image of the purchased item and the real color of the purchased item may lead a user to want to return the item to electronic commerce vendor. These returns result in the profit margins of the electronic commerce vendors being diminished by a significant amount. Other variations in how an item are described to the physical attributes can also lead to a large amount of returns to electronic commerce vendors as well.

To limit the number of returns, a vendor can provide high quality images of items to be purchased where each image of the vendor is presented with a high dynamic color gamut and resolution. The problem with the presentation of such images is that the user may have a display device which is incapable of taking advantage of such high quality images. In addition, different users perceive the same color in different ways. For example, one user may be color blind while a second user may not be able to distinguish between different shades of a color. In addition, although a picture of an item may be a good representation of such item, currently there is not a good way to portray other physical characteristics of an item accurately.

Thus, a method and apparatus is needed to help account for these differences in how people perceive an item's characteristics (e.g., the color of the item, texture of an item, and the like) compared to how an item is described.

### BRIEF SUMMARY

One embodiment of the disclosure describes a method for presenting information about a user selected item. A determination is made about the attributes of the selected item and from such attributes sample items are shown to a user which have similar attributes to that of the user selected item. The user is presented with a representation of the sample item and is provided with information as to what attribute of the sample item is similar to that of the user selected item.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 shows a block diagram of an embodiment of a system for delivering images of items to a user in accordance with the principles of the present disclosure;

FIG. 2 shows a block diagram of an embodiment of a server in accordance with the principles of the present disclosure;

FIG. 3 shows a block diagram of an embodiment of a playback device in accordance with the principles of the present disclosure;

FIG. 4 presents a flow chart of an embodiment of the present disclosure for modifying different images of items for purchase from an electronic vendor in accordance with the principles of the present disclosure;

FIG. 5 presents a representation of a user interface that presents multiple modified images of the same original image in accordance with the principles of the present disclosure;

FIG. 6 presents a flow chart of an embodiment of the present disclosure for recommending sample items when a user selects an item in accordance with the principles of the present disclosure;

FIG. 7 presents a representation of a user interface that enables a user to select an item in accordance with the principles of the present disclosure; and

FIG. 8 presents a representation of a user interface that provides information about sample items that have similar attributes of that of a selected item in accordance with the principles of the present disclosure.

It should be understood that the drawing(s) is for purposes of illustrating the concepts of the disclosure and is not necessarily the only possible configuration for illustrating the disclosure.

### DETAILED DESCRIPTION OF THE INVENTION

It should be understood that the elements shown in the Figures can be implemented in various forms of hardware, software or combinations thereof. Preferably, these elements are implemented in a combination of hardware and software on one or more appropriately programmed general-purpose devices, which can include a processor, memory and input/output interfaces. Herein, the phrase “coupled” is defined to mean directly connected to or indirectly connected with through one or more intermediate components or signal paths. Such intermediate components can include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes that can be substantially represented in computer readable media and so executed by a computer or processor, whether or not such computer or processor is explicitly shown. The computer readable media and code written on can be implemented in a transitory state (signal) and a non-transitory state (e.g., on a tangible medium such as CD-ROM, DVD, Blu-Ray, Hard Drive, flash card, or other type of tangible storage medium).

The functions of the various elements shown in the figures can be provided through the use of dedicated hardware as well as hardware capable of executing software in association with appropriate instructions. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read only memory (“ROM”) for storing software, random access memory (“RAM”), and nonvolatile storage.

Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

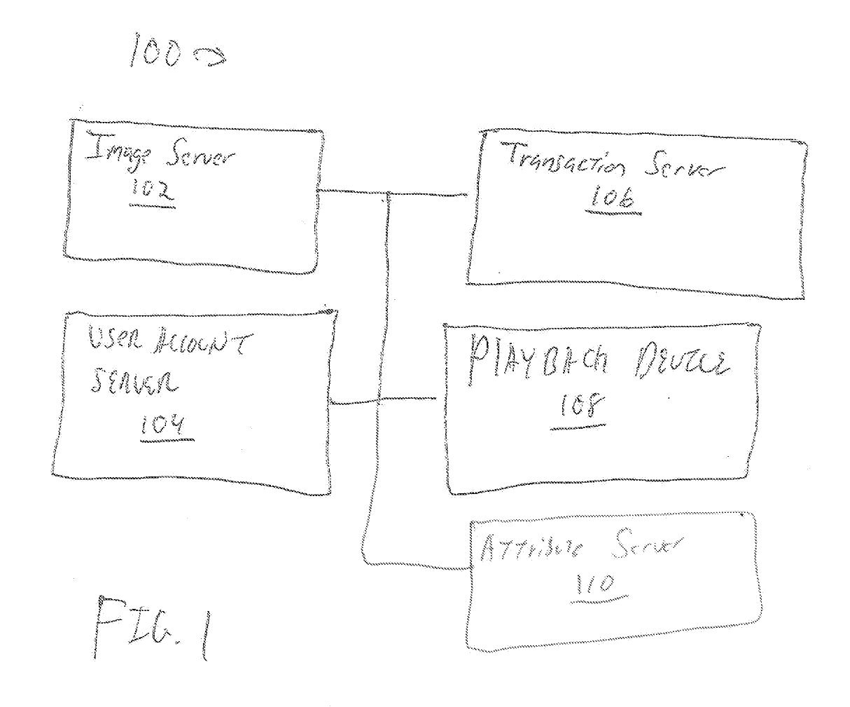

FIG. 1 shows a block diagram of an embodiment of a system 100 for delivering images of items from an electronic commerce vendor to a user in accordance with the principles of the present disclosure where each of the display components are coupled to each other using a network connection, wired connection, wireless connection, and the like. Image server 102 is configured to supply images of items to playback device 108. The transactional data corresponding to when a user purchases items come from transaction server 106 that provides a user with the ability to purchase items from the electronic commerce vendor. Ideally, transaction server 106 will authorize a purchase of selected items of a user and coordinate the delivery of such items to an address specified by the user. Transactional server 106 can also be configured to retain transactional data of items previously purchased by a user.

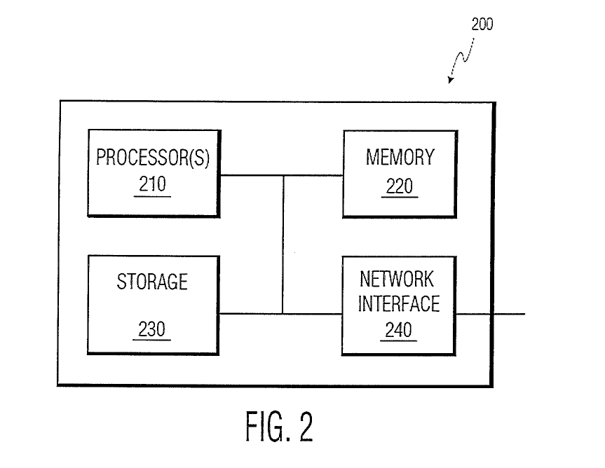

Referring back to image server 102, a database can be implemented in the memory 220 or storage 230 (FIG. 2) of image server 102 that stores images of items available from an electronic commerce vendor. The database contains various information about the items including the price and characteristics of such items. Image server 102 can be configured to modify the images of the same item by adjusting the chrominance, luminance, RGB values, CMYK, and the like values of an item.

User account server 104 can be configured as a server to retain information about a user's payment information, address book of places to deliver purchased items, transactional information of previous user purchases from an electronic commerce vendor, and other information that can be used for electronic commerce transactions.

Playback device 108 can be configured to provide a user with the ability to select an image of items available from an electronic commerce vendor, purchased items from via image server 102 and transactional server 108, and search for items available from the electronic commerce vendor. Playback device 108 can be a computer, video game system, display device, tablet, phone, smart watch, wearable device, set top box, electronic book reader, digital audio music player, and the like.

Attribute server 110 is coupled to the other devices in system 100 such as image server 102, user account server 104, transaction server 106, and playback device 108. Specifically, attribute server 110 is used to store information about items that are for sale from an electronic commerce vendor where such information typically comprises textual information describing such items for sale. Items can be described in a manner where physical attributes of items such as, color, size, pattern, taste, texture, smell, fit, fabric, handling care (cleaning instructions like cold wash only, dry clean only, etc.), designer, style, material, weight, dimensions, performance characteristics, and the like are used to describe how an item looks, feels, tastes, smells, and the like. Other attributes could be, but are not limited to, an item's compatibility with an operating system, game platform, compatibility with a home network, The physical attributes of each item can be stored as metadata in attribute server 110 where the metadata is stored in a database complied by a search engine, data that is curated by humans, determined from manufacturer specifications, determined by surveys, and the like. Metadata from attribute server 110 can be matched with images that are stored in image server 102 when a user requests information about a particular item where a graphic representation of an item is shown with a corresponding description.

TABLE 1 presents an exemplary embodiment of different metadata that can be stored in attribute server 110 which includes different attributes for clothing items such as shirts. The exemplary attributes include color, pattern, texture, fit, and handling care although other attributes can be used in accordance with the exemplary principles. TABLE 1 is also configured to store information about whether or not a user has purchased an item before where such information can be obtained from transaction server 106, although other mechanisms can be used to obtain such information in accordance with the exemplary principles.

TABLE 1

| | | | | | Handling | Purchased |
|---|---|---|---|---|---|---|
| Shirt # | Color | Pattern | Texture | Fit | Care | by User |
| Shirt 1 | Red | Stripes | Velvet | Loose | Dry Clean | No |
| | | | | | Only | |
| Shirt 2 | Red | Solid | Plush | Loose | Hot Water | No |
| | | | | | Fine | |
| Shirt 3 | Red | Stripes | Denim | Baggy | Cold Water | Yes |
| | | | | | Only | |
| Shirt 4 | Blue | Solid | Denim | Baggy | Cold Water | Yes |
| | | | | | Only | |
| Shirt 5 | Blue | Stripes | Plush | Tight | Dry Clean | Yes |
| | | | | | Only | |
| Shirt 6 | Blue | Solid | Velvet | Tight | Hot Water | Yes |
| | | | | | Fine | |

From the information in TABLE 1, a user can obtain a description about items, called sample items that are similar to or match an item that a user wants to purchase. For example, if a user is looking to purchase Shirt 1, a user can obtain information about sample items that have physical attributes that are similar to that of Shirt 1. Shirt 1's color red is noted by attribute server 110 as being similar to that of Shirt 2 and Shirt 3. Using such information, a user if they possess either Shirt 2 or Shirt 3 can look at such shirts to see the real color of these items of clothes.

Likewise, if a user is interested in how Shirt 1 would fit, attribute server 110 would indicate that Shirt 2 has a fit that is loose just like that of Shirt 1. Shirt 3, Shirt 4, Shirt 5, and Shirt 6, would not be shown for the fit query because such shirts do not share the same fit attribute as that of Shirt 1. Continuing with this example, data can be stored to indicate whether or not a user has previously purchased items and/or whether a user owns items. In the present example, a user previously purchased Shirt 3, Shirt 4, Shirt 5, and Shirt 6, while Shirt 1 and Shirt 2 is not owned by a user. The inventory of items owned by a user can also be inputted by a user using a user interface, scanning the UPC codes of such items, scanning the QR codes of such items, using a menu to select representations of such items and the like.

In a second example, the disclosed principles can be used for other items as well. For example, if a person were interested in purchasing a perfume 1 (as a user selected item), the person could be informed by the system about a first sample item perfume that has a similar smell to that of perfume 1 and a second sample perfume that uses a similar bottle to that of the perfume 1. Likewise, if a person was interested in purchasing a particular dish (as a user selected item), the person could be informed about a first sample item dish that has a pattern that is similar to that of the dish and a second sample item dish that is made out of the same material than that of the particular dish of interest. Other items and attribute comparisons can be made in accordance with the disclosed principles.

FIG. 2 depicts an exemplary server 200 that can be used for implementing any one of the media server 102, user account server 104, transaction server 106, digital locker 110, and the like. The server includes one or more processors 210, memory 220, storage 230, and a network interface 240. Each of these elements will be discussed in more detail below.

The processor 210 controls the operation of the server 200. The processor 210 runs the software that operates the server as well as provides the functionality of the software required to operate any one of the servers (102, 104, 106, 110). The processor 210 is connected to memory 220, storage 230, and network interface 240, and handles the transfer and processing of information between these elements. The processor 210 can be general processor or a processor dedicated for a specific functionality. In certain embodiments there can be multiple processors.

The memory 220 is where the instructions and data to be executed by the processor are stored. The memory 220 can include volatile memory (RAM), non-volatile memory (EEPROM), or other suitable media. Memory 220 can be configured to operate a database to support any one of the operations required for servers (102, 104, 106, 110) in accordance with the described principles under the direction of processor 210.

The storage 230 is where data is stored for the use of processor 210 in executing the described operations. Storage 230 can be magnetic media (hard drive), optical media (CD/DVD-Rom), or flash based storage. Storage 230 can be configured to operate a database to support any of the operations required for server (102, 104, 106, 110) in accordance with the described principles under the direction of processor 210. Storage 230 can also be configured to store information comporting to user account data, transaction data, information comporting to previous media asset transactions by a user, media assets, and the like.

Network interface 240 handles the communication of server 200 with other devices over a network. Examples of suitable networks include Ethernet networks, Wi-Fi enabled networks, cellular networks, and the like. Other types of suitable networks will be apparent to one skilled in the art given the benefit of the disclosure.

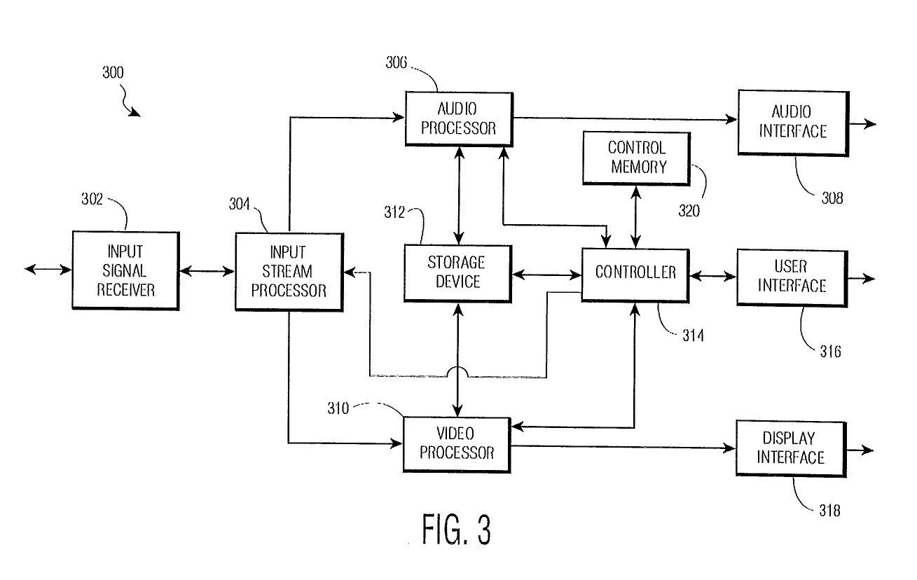

In the playback device 300 shown in FIG. 3, image information and corresponding information used for purchasing items are received via input signal receiver 302. The input signal receiver 302 can be one of several known receiver circuits used for receiving, demodulation, and decoding signals provided over one of the several possible networks including over the air, cable, satellite, Ethernet, fiber and phone line networks. The desired input signal can be selected and retrieved in the input signal receiver 302 based on user input provided through a control interface (not shown). The decoded output signal is provided to an input stream processor 304. The input stream processor 304 performs the final signal selection and processing, and includes separation of video content from audio content for the content stream. The audio content is provided to an audio processor 306 for conversion from the received format, such as compressed digital signal, to an analog waveform signal. The analog waveform signal is provided to an audio interface 308 and further to the display device 114 or an audio amplifier (not shown). Alternatively, the audio interface 308 can provide a digital signal to an audio output device or display device using a High-Definition Multimedia Interface (HDMI) cable or alternate audio interface such as via a Sony/Philips Digital Interconnect Format (SPDIF). The audio processor 306 also performs any necessary conversion for the storage of the audio signals.

The video output from the input stream processor 304 is provided to a video processor 310. The video signal can be one of several formats. The video processor 310 provides, as necessary a conversion of the video content, based on the input signal format. The video processor 310 also performs any necessary conversion for the storage of the video signals.

Storage device 312 stores audio and video content received at the input. The storage device 312 allows later retrieval and playback of the content under the control of a controller 314 and also based on commands, e.g., navigation instructions such as next item, next page, zoom, fast-forward (FF) and rewind (Rew), received from a user interface 316. The storage device 312 can be a hard disk drive, one or more large capacity integrated electronic memories, such as static random access memory, or dynamic random access memory, or can be an interchangeable optical disk storage system such as a compact disk drive or digital video disk drive. In one embodiment, the storage device 312 can be external and not be present in the system.

The converted video signal, from the video processor 310, either originating from the input or from the storage device 312, is provided to the display interface 318. The display interface 318 further provides the display signal to a display device of the type described above. The display interface 318 can be an analog signal interface such as red-green-blue (RGB) or can be a digital interface such as high definition multimedia interface (HDMI).

Controller 314 is interconnected via a bus to several of the components of the device 300, including the input stream processor 302, audio processor 306, video processor 310, storage device 312, and a user interface 316. The controller 314 manages the conversion process for converting the input stream signal into a signal for storage on the storage device or for display. The controller 314 also manages the retrieval and playback of stored content. Furthermore, as will be described below, the controller 314 performs searching of content, either stored or to be delivered via the delivery networks described above. The controller 314 is further coupled to control memory 320 (e.g., volatile or non-volatile memory, including random access memory, static RAM, dynamic RAM, read only memory, programmable ROM, flash memory, EPROM, EEPROM, etc.) for storing information and instruction code for controller 314. Further, the implementation of the memory can include several possible embodiments, such as a single memory device or, alternatively, more than one memory circuit connected together to form a shared or common memory. Still further, the memory can be included with other circuitry, such as portions of bus communications circuitry, in a larger circuit.

User interface 316 of the present disclosure can employ an input device that moves a cursor around the display, which in turn causes the content to enlarge as the cursor passes over it. In one embodiment, the input device is a remote controller, with a form of motion detection, such as a gyroscope or accelerometer, which allows the user to move a cursor freely about a screen or display. In another embodiment, the input device is controllers in the form of touch pad or touch sensitive device that will track the user's movement on the pad, on the screen. In another embodiment, the input device could be a traditional remote control with direction buttons.

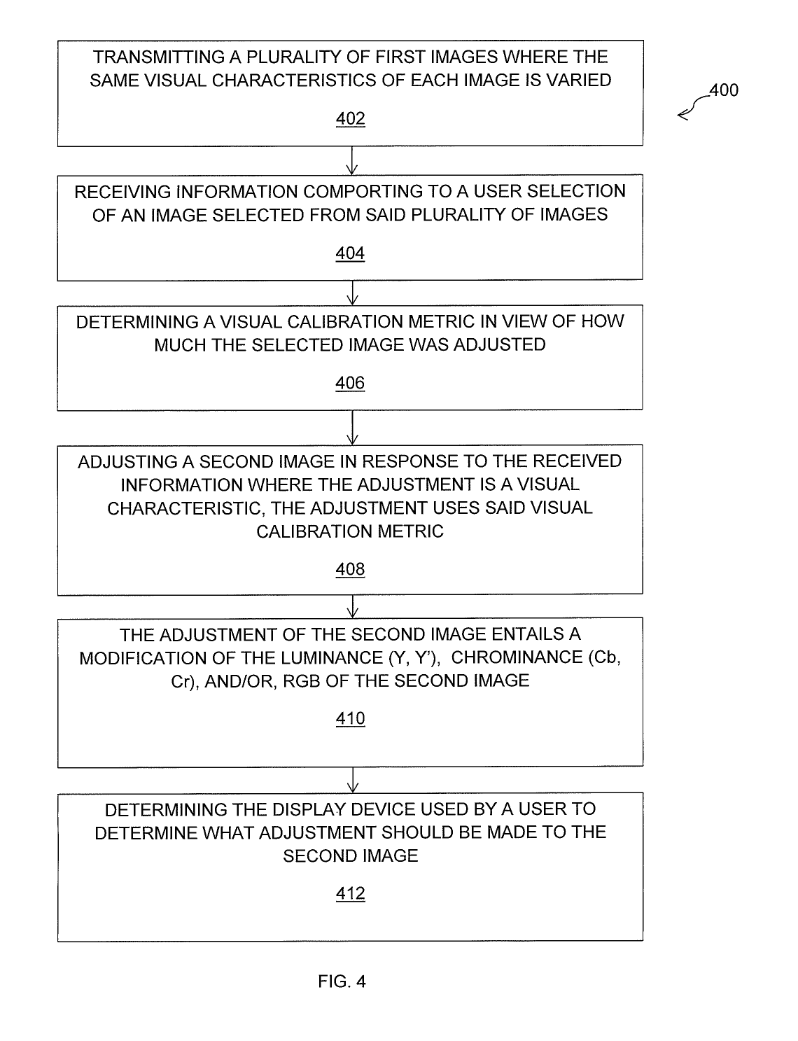

FIG. 4 presents a flow chart of 400 of an exemplary embodiment for modifying different images of items for purchase from an electronic vendor. The method will present multiple images of item that a user previously purchased from an electronic vendor. The exemplary embodiment has each image varied in such a way where the visual characteristics of such images (such as the luminance, chrominance, RGB, and the like) of the images changes from image to image. For example, each image is presented with a different color shade, brightness is varied from image to image, and the like. When an image is selected by a user, a visual calibration metric is determined which comports to the changes made to a selected image. This visual calibration metric can then be applied to all images transmitted by image server 102.

In step 402, image server 102 transmits a plurality of first images where the same visual characteristic for each image is changed, and each image is generated from the same original image. Preferably, the image used comports to an item previously bought from the electronic vendor and physically delivered to a user. The user can then use such the physical item as a reference against the images shown on a display device to select the presented item that represents the best match for the physical version of the item. Ideally, the modified images will comport to a YCbCr color space, Y′CbCr color space, RGB color space, CMYK color space, and the like where respective luminance, chrominance, and the like can be modified from image to image. Note, optionally, multiple modifications can be made to an original image. For example, the luminance can be modified from an original image for one of the plurality of images while the chrominance can be modified from an original image for a second one of the plurality of images.

Step 404 lets a user select an image from the presented images where the user can compare the physical item against the presented images. The selection of what image a user selected is received by image server 102. Image server 102 determines from the received information the manner in which a selected image was changed from an original image. In an illustrative example, the luminance component for each image shown in step 402 is modified by a certain amount. When a user selects a modified image with a changed luminance, the image server 102 knows how the luminance value of the selected image was changed whereby image server 102 can apply such a change to subsequently generated and transmitted images.

In step 406, the varied visual component of an selected image can be used to determine a visual calibration metric which can be used to change a characteristic (e.g., Y, Y′, Cb, Cr, and the like components) of subsequently rendered images. The calibration metric, in step 408, can be used to modify a visual characteristic of all subsequently rendered images. As previously stated, such visual characteristics can be the chrominance, luminance, or other visual elements of such rendered images. Preferably, the subsequent images comport to items that are available for purchase through the electronic vendor.

In step 410, the adjustment of the second image entails a modification to the chrominance, luminance, and the like of an image to be rendered. Optionally, in step 412, the display device used by a user is determined, where the modification to subsequent images are made in view of such a determination. For example, if it known that a particular display device tends to have a high brightness for displayed images, the display of all subsequent images will be modified to account for such a brightness. This determination can be made by querying a playback device 108 and requesting attributes about a coupled display device including the model, display technology, and other attributes associated with the display device.

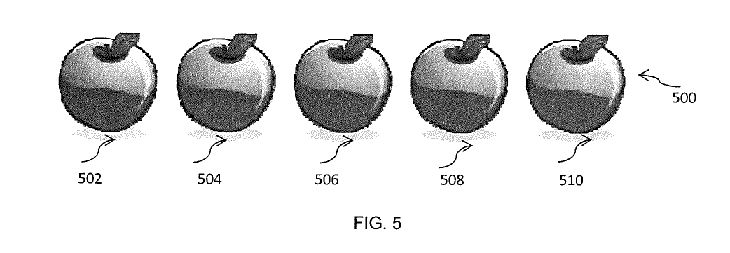

FIG. 5 presents a representation of a user interface 500 that presents multiple modified images of the same original image in accordance with the principles of the present disclosure. A number of images 502, 504, 506, 508, and 510 of an original image of an item that was previously purchased from an electronic retailer (an apple in this case) where each presented image has a visual characteristic modified in accordance with the principles. Based on which picture is selected by a user, a visual characteristic can be developed and applied to the display of subsequent images of items to purchase. Other examples of user interfaces are possible in accordance with the disclosed principles.

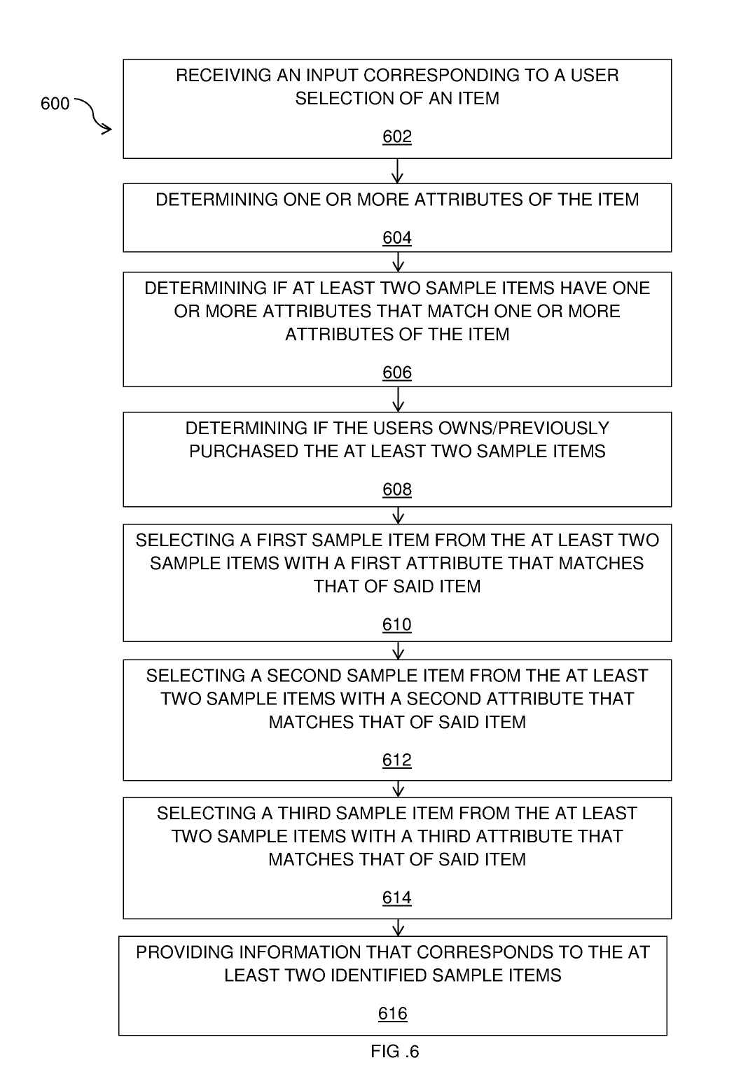

FIG. 6 presents a flow chart of 600 of an exemplary embodiment for recommending sample items that have physical attributes that are similar to that of an item selected by a user. In step 602, an input corresponding to a user selection of an item is received by attribute server 110. In step 604, in response to the receipt of the received user selection attribute server 110 determines one or more attributes of the item by conducting a lookup of a database that is part of attribute server 110 to obtain information that is similar to that as shown in TABLE 1. Other information can be obtained in accordance with the exemplary principles of the present disclosure.

In step 606, attribute server 110 makes a determination if at least two or more sample items have one or more attributes that match the attributes of the user selected item. The one or more attributes are preferably physical attributes such as color, size, texture, and the like, although other attributes can be used in accordance with the principles of the present invention. In step 608, a determination is made via attribute server 110 whether or not a user owns or has previously purchased sample items which have attributes that match a selected item. Such information can be obtained in response to a user entry of their inventory of items and/or in response to information obtained from transaction server 106. Other approaches for obtaining such information can be performed in accordance with the exemplary principles of the present disclosure. Preferably, attribute server 110 is configured to provide only sample items that are owned or have been purchased by a user, but this does not need to be the case in order for the principles of the present disclosure to be applied.

Attribute server 110, in step 610, provides a first sample item from the at least two sample items where a first attribute associated with the first sample item matches or is similar to that attribute of the user selected item. For example, it can be determined that the user selected item has a pattern (argyle) that is similar to that of the first sample item. Because of this similarity, the first sample item would be selected via attribute server 110 in step 610. In step 612, a second sample item from the at least two sample items is selected where a second attribute of the user selected item matches that of the second sample item. The second attribute for step 612 is preferably different than the first attribute that is selected from step 610. In an optional embodiment of steps 610 and 612, a user can indicate a ranking for which they want attributes to be ranked where different physical attribute such as fit would be given a higher ranking than that of texture or smell. The different physical attributes can be ranked in accordance of the preferences of a user in accordance with the exemplary principles.

In step 614, a third sample item from the at least two sample items with a third attribute is selected by attribute server 110 where the third attribute of the item matches that of the third sample item. Preferably, the first, second, and third attributes are different from each other. In step 616, information corresponding to the at least two identified sample items are provided where such information can be a description of the sample items, pricing information, graphic information, textual information, sounds, and the like.

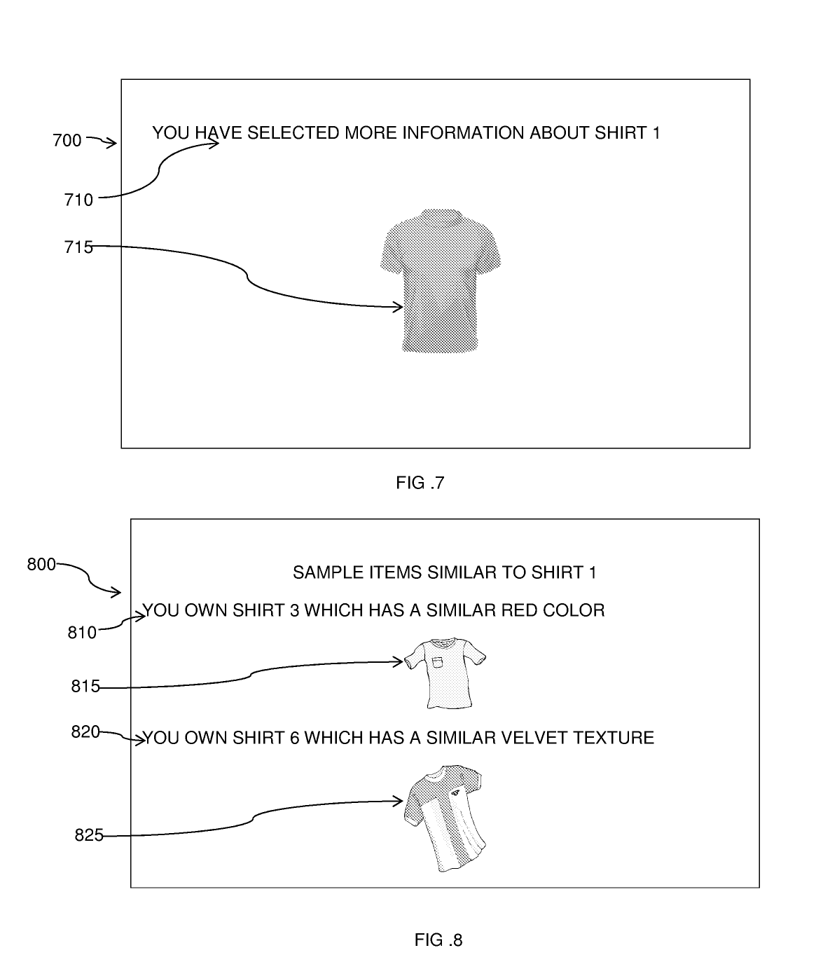

FIG. 7 represents an exemplary embodiment of a user interface 700 that is used for selecting information about an item. Specifically, text 710 indicates that a user has selected an item known as Shirt 1 where a representation of the shirt image 715 is shown. Such information can be obtained by the operation of attribute server 110 that contains descriptive information about Shirt 1 and image server 102 that stores images of items such as image 715.

FIG. 8 represents an exemplary embodiment of a user interface 800 that displays information about sample items that are similar to a selected item. Attribute server 110, in accordance with the principles listed previously regarding TABLE 1, determines that sample item Shirt 3 and sample item Shirt 6 are already owned by a user by using information that can come from transaction server 106. Attribute server 110 also determines in this situation that Shirt 1 shares the common attributes of color with Shirt 3 and texture with Shirt 6 where such relationships are shown in the representation of user interface 800.

Text 810 indicates that sample item Shirt 3 is owned by the user and that Shirt 1 and Shirt 3 has a similar red color. Image 815 shows a representation of Shirt 3 which is obtained from image server 102. Text 820 lists that sample item Shirt 6 is also owned by the user and that Shirt 1 and Shirt 6 have a similar velvety texture. Different types of physical attributes, descriptive information, sample items, and the like can be used for different embodiments of the presented exemplary user interfaces.

Although embodiments which incorporate the teachings of the present disclosure have been shown and described in detail herein, those skilled in the art can readily devise many other varied embodiments that still incorporate these teachings. Having described preferred embodiments for a system and method for gesture recognition (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method for recommending items comprising the steps of:
receiving input corresponding to a user selection of an item;
determining at least two sample items that are related to the item using the input; and
providing information corresponding to the at least two identified sample items.

2. The method of claim 1 where the determining step further comprises the steps of:
determining one or more attributes of the item; and
determining the at least two sample items that have one or more attributes matching one or more attributes of the item.

3. The method of claim 2 wherein the determining step further comprises selecting a first attribute and a second attribute from the one or more attributes of the item.

4. The method of claim 3 comprising the additional steps of:
receiving a second input corresponding to a ranking of attributes selected from the one or more attributes of the item; and
selecting the first and second attributes using the ranking of attributes.

5. The method of claim 3 wherein the determining step further comprises selecting a first sample item from the at least two sample items where the first sample item and the item have the first attribute that matches.

6. The method of claim 5 where the determining step further comprises selecting a second sample item from the at least two sample items where the second sample item and the item have the second attribute that matches.

7. The method of claim 6 comprising the additional steps of:
selecting a third attribute from the one or more attributes; and
selecting a third sample item from the at least two sample items where the third sample item and the item have a third attribute that matches.

8. The method of claim 6 wherein the first sample item and the second sample item are different and the first attribute and the second attribute are different.

9. The method of claim 2 wherein the one or more attributes of the item are a plurality of physical attributes.

10. The method of claim 9 wherein the plurality of physical attributes having at least one element selected from a group consisting of:
color;
size;
pattern;
taste;
texture;
smell;
fit;
fabric;
handling care;
designer;
style;
material;
weight;
dimensions; and
performance characteristics.

11. The method of claim 10 wherein the plurality of physical attributes are stored as metadata in a database.

12. The method of claim 2 wherein the at least two sample items are selected from a listing of items previously purchased by a user from an electronic commerce vendor.

13. The method of claim 2 wherein the at least two sample items are selected from a listing of items that a user owns.

14. An apparatus for recommending items comprising:
an interface configured to receive input corresponding to a user selection of an item;
a processor configured to determine at least two sample items that are related to the item using the input; and
the processor configured to provide information corresponding to the at least two identified sample items.

15. The apparatus of claim 14 further comprises:
the processor configured to determine one or more attributes of the item;
the processor configured to determine the at least two sample items that have one or more attributes matching one or more attributes of the item.

16. The apparatus of claim 14 further comprising that the processor configured to select a first attribute and a second attribute from the one or more attributes of the item.

17. The apparatus of claim 16 further comprising:
the interface configured to receive a second input corresponding to a ranking of attributes selected from the one or more attributes of the item; and
the processor configured to select the first and second attributes using the ranking of attributes.

18. The apparatus of claim 15 wherein the processor configured to select a first sample item from the at least two sample items where the first sample item and the item have the first attribute that matches.

19. The apparatus of claim 15 wherein the processor configured to select a second sample item from the at least two sample items where the second sample item and the item have the second attribute that matches.

20. The apparatus of claim 19 further comprising:
the processor configured to select a third attribute from the one or more attributes; and
the processor configured to select a third sample item from the at least two sample items where the third sample item and the item have a third attribute that matches.

21. The apparatus of claim 19 wherein the first sample item and the second sample item are different and the first attribute and the second attribute are different.

22. The apparatus of claim 14 wherein the one or more attributes of the item are a plurality of physical attributes.

23. The apparatus of claim 22 wherein the plurality of physical attributes having at least one element selected from a group consisting of:
color;
size;
pattern;
taste;
texture;
smell;
fit;
fabric;
handling care;
designer;
style;
material;
weight;
dimensions; and
performance characteristics.

24. The apparatus of claim 22 wherein the plurality of physical attributes are stored in a memory as metadata in a database.
